(19) United States
(12) Patent Application Publication
(10) Pub. No.: US 2023/0390038 A1
(43) Pub. Date: Dec. 7, 2023

(54) Method For Cleaning Surfaces

(71) Applicant: epitome GmbH, Wien (AT)

(72) Inventors: Bernhard Weiss-Bouslama, St. Andrä-Wördern (AT); Wilhelm Zackl, Wien (AT); Bernhard Rieder, Wien (AT); Lukas Rösch, Wien (AT); Florian Schellnast, Pressbaum (AT)

(73) Assignee: epitome GmbH, Wien (AT)

(21) Appl. No.: 18/203,098

(22) Filed: May 30, 2023

(30) Foreign Application Priority Data
Jun. 1, 2022 (DE) 10 2022 113 821.6

(51) Int. Cl. A61C 17/02; B08B 3/02; B08B 3/10

(52) U.S. Cl. CPC A61C 17/02; B08B 2203/007; B08B 3/10; B08B 3/02

(57) ABSTRACT

The invention relates to a method for cleaning surfaces, wherein a liquid volume is produced around a surface to be cleaned and, using at least one assembly comprising at least one nozzle and a heating device, vapor bubbles composed of wet vapor or saturated vapor and/or bubbles composed of a superheated vapor are produced and are directed by the at least one nozzle at the surface to be cleaned.

### RELATED APPLICATIONS

This patent application claims priority under 35 USC § 119 based on German Patent Application DE 10 2022 113 821.6, filed on Jun. 1, 2022, the disclosure of which is incorporated by reference.

### FIELD OF THE INVENTION

The invention relates to a method for cleaning surfaces and in particular a method for cleaning surfaces in an oral cavity.

### BACKGROUND OF THE INVENTION

In the field of tooth cleaning, improvements in cleaning are continuously being sought. Conventional cleaning with a toothbrush and toothpaste has a number of disadvantages.

Conventional toothpastes have up to 20% abrasive components; the abrasive components together with excessive pressure on the brush by the user can lead to massive erosion of tooth material over time. With the increasing average life expectancy, this has led to the fact by the time old age is reached, teeth have been veritably brushed to death and this leads to problems.

In addition, the toothbrush has the disadvantage that it can damage the gums, particularly when brushing is not performed properly so that periodontal disease is a common problem. Most of the biofilm that forms the contamination is located directly above or below the gums, which is why cleaning at or next to the gums is very important. This is particularly difficult for toothbrushes because the brush comes into contact with the gums and irritates them.

In addition, brushing with a toothbrush and toothpaste is not sufficient from an oral hygiene standpoint because in particular, the interdental spaces (up to 40% of the surface to be cleaned) and the gingival pockets are not cleaned sufficiently because the toothbrush does not reach these regions.

Plaque (=oral biofilm), which is formed by bacterial processes and from which tartar forms in later stages, is a film of contamination that adheres to surfaces and to itself comparatively well and cannot be easily removed, even when it is cleaned by direct contact with the toothbrush, but certainly not in the interdental spaces, into which the toothbrush can only penetrate to a limited degree or not at all.

Conventional cleaning with a toothbrush therefore requires additional cleaning measures such as the use of dental floss or interdental brushes to clean in the interdental spaces, particularly the regions where the teeth abut each other, but also the interdental spaces. Even when using dental floss, however, there is a certain possibility of misuse, because in particular the gums can also be injured with dental floss, particularly in the region of the interdental pockets, where the bacterial load is particularly high. This can lead to gingivitis, among other things.

In the past, there have been a variety of attempts to develop other approaches to cleaning. For example, it is also known to clean the interdental spaces with water jet devices. It has turned out that although the water jet devices of earlier times were in fact able to produce a cleaning effect, the hardness of the jet could easily damage the gums. Modern devices have been significantly reduced in terms of the jet power so that they no longer cause immediate damage to the gums, but this has also reduced the cleaning performance so much that these devices are largely ineffective.

In addition, many attempts have been made to provide so-called ultrasonic brushes, in which a vibration of the toothbrush, which is used for cleaning and ultimately, together with toothpaste, in turn produces an abrasive cleaning, is combined with ultrasonic vibrations, which are supposed to produce a cleaning effect. It has turned out, though, that such toothbrushes are not able to couple the ultrasound into the oral cavity in such a way that it would even be possible to verify the production of any such cleaning effect. Such so-called ultrasonic toothbrushes are therefore not significantly better than a conventional manual toothbrush.

Other electric toothbrushes in which the brush head makes circular or vibrating movements do often have pressure control, but ultimately these movements also result in an abrasive brushing.

In the field of contactless cleaning, the cleaning effect of imploding or collapsing vapor bubbles has been debated in recent years. Such vapor bubbles have been obtained either through the use of ultrasound, through spot heating by means of lasers, or by means of hydrodynamic cavitation. The implosion of vapor bubbles is supposed to produce hydrodynamic liquid jets, which when they strike the tooth surface, detach the biofilm with the aid of the powerful shear forces that are produced.

The prior approaches presented wrestle with two different kinds of challenge: on the one hand, the size of the vapor bubble produced, which also determines the cleaning intensity, is very difficult to control. On the other hand, the vapor bubbles are produced very close to an actuator (e.g. vibrating scaling tool) where, because of their short life span, they implode immediately, which minimizes the cleaning distance. This method in turn enables an exclusively local application in the segment of professional tooth cleaning.

DE 20 2016 101 191 U1 discloses a brush head for an electric toothbrush, which is intended to surround the tooth on all sides and on which bristles are positioned for cleaning.

U.S. Pat. No. 3,401,690 A discloses a cleaning device in which ultrasound is applied to a surface via a liquid through a clamp, which embraces at least one tooth.

US 2005/091770 A discloses a toothbrush that works like a normal electric toothbrush, but also has an ultrasonic generator, which is to introduce acoustic energy into a cleaning liquid.

US 2017/0189149 A1 discloses a system for whitening teeth with an ultrasonic device. A mouthpiece is provided for this purpose, which has a volume for the upper jaw and a volume for the lower jaw; ultrasonic generators are positioned in the mouthpiece facing the teeth and can apply ultrasonic energy to the tooth surface.

This is intended to produce an effect known as ultrasound streaming; it is stated that the temperature must be controlled and also bubbles must be prevented from forming since they hinder the transmission of the ultrasound. A frequency of 20 kHz to 100 kHz is to be used in this case; the purpose of this is to deliberately induce a cavitation so that vapor bubbles form which implode on the surface of the tooth, the purpose of which is to generate local temperatures of up to 5000 Kelvin and local pressures of up to 1000 atmospheres.

The disadvantage here is that the amounts of energy introduced are so high that damage to the tissue is practically inevitable.

WO2007/060644 A2 discloses a method and device for removing biofilm by means of so-called “microstreaming.” In this case, the intent is to cause gas bubbles to resonate by means of ultrasound, which is supposed to result in a cleaning effect. The purpose of the ultrasonic excitation is to cause the gas bubbles to vibrate, which induces an acoustic streaming in a small region in the vicinity of the bubble. This acoustic streaming is also known as microstreaming. This microstreaming is supposed to generate shear a force capable of removing the biofilm. The corresponding gas bubbles can be prefabricated and in particular, these bubbles can also be generated in a phospholipid or protein environment to stabilize them.

WO2009/077291 A2 also discloses a method for introducing antimicrobial reagents into a biofilm; in this case, gas bubbles are introduced into a treatment chamber in a plastic envelope, the plastic envelope is then destroyed by ultrasound and the bubbles are thus released. The gas bubbles, in turn, are excited by the ultrasound frequency so that they vibrate and after reaching a maximum amplitude of vibration, collapse, thus rupturing the biofilm.

WO2010/076705 A1 discloses a toothbrush that, in addition to bristles, contains an ultrasonic generator that introduces ultrasound into a treatment chamber, with microbubbles also being introduced. This can, but does not have to, produce cavitation.

WO2020/212214 A1 discloses a method in which a toothbrush is to be coupled to a water jet device, the water jet device being controlled in such a way that when the toothbrush is guided past the interdental spaces, a water jet rinses the interdental spaces. Suitable acceleration, velocity, or displacement sensors are to be used for this purpose.

WO 2020/212248 A1 discloses a method in which a water jet device is also coupled to a toothbrush; a controller is provided, which uses predetermined data and user-specific data to estimate the location of the cleaning device in the mouth, said data including, among other things, data relating to the cleaning activity of the user or the operation of the cleaning device and being used to estimate the location in order, when an interdental space is reached, to rinse it with the water jet.

A disadvantage of the known methods is that experiments have shown that cleaning with ultrasound-produced (imploding) bubbles alone is not sufficient. Either the cleaning performance is too low or the cleaning performance is higher, but at a higher cleaning performance that is not necessarily sufficient, an energy range is reached that is not safe, since in these energy ranges, cavitation can occur that can in certain spots result in destruction of both the gums and the tooth material. In order to preclude the occurrence of such destruction, this range must be avoided by a rather large margin, which results in ineffective cleaning performance. Ultimately, combining microbubbles with conventional toothbrushes only combines the disadvantages of the two technologies.

It has also turned out that the ultrasound-produced bubbles do not reliably achieve a cleaning of all of the surfaces to be cleaned, i.e. also including the interdental spaces.

### SUMMARY OF THE INVENTION

The object of the invention is to create a method for cleaning surfaces, which detaches the biofilm simply, quickly, and safely, and also effectively and in a non-hazardous manner.

The object is attained with the features described and claimed herein.

Advantageous modifications are disclosed and claimed herein.

Another object is to create a device for cleaning surfaces that ensures a simple, quick, safe, and also effective cleaning of biofilm.

The object is attained with the features described and claimed herein.

Advantageous modifications are disclosed and claimed herein.

The inventors have discovered that although ultrasound-produced bubbles are indeed suitable for damaging the biofilm, it has nevertheless turned out that the biofilm—like a hook and loop fastener—tends to quickly close back up again and stick to both itself and a tooth surface so that although the biofilm is loosened initially, it cannot be detached or removed. This is clearly due to the fact that the flow conditions and particularly the often used and described microstreaming are not sufficient for a reliable cleaning. It has also been determined that the throwing range of the bubbles is insufficient and/or covers too short of a distance range.

According to the invention, a surface to be cleaned is surrounded with a closed liquid volume. Inside the closed liquid volume, pulsed heating-produced vapor bubbles and in particular superheated vapor bubbles are produced and directed at a surface to be cleaned.

The bubbles according to the invention are about 10 times larger than bubbles that can be produced by ultrasound, particularly by ultrasound with an energy input that does not damage the teeth and tissues.

According to the invention, the transport of the bubbles can be carried out by means of two basic methods that can also be used in combination.

A first way is to produce a vapor bubble by heat input, wherein a liquid volume in front of the vapor bubble in the ejection direction in a nozzle assembly is ejected by means of the expansion. This ejected volume in particular produces a pressure jet or pressure pulse of a predetermined strength and velocity at a surface to be cleaned. Due to the nature of the liquid or liquid medium, the pressure surge, which introduces a small volume of liquid into the liquid volume, propagates through the surrounding liquid to a surface to be cleaned.

According to the fluid dynamics, a negative pressure is produced at the rear end of the pressure surge so that the vapor bubble is entrained by this lower-pressure region, wherein behind the vapor bubble, liquid to be vaporized with a certain pressure is fed into the region of the heater and from there, onward to an ejection opening. The process then begins again with a heating procedure.

This process can be further assisted by an appropriately cyclical pulsation of the supply of the liquid to be vaporized.

In this case, the vapor bubbles can be produced by nozzles of different lengths and/or diameters so that different-sized vapor bubbles can be produced, which experience has shown also have different throwing ranges.

If certain nozzle geometries are maintained, the vapor bubbles can also be produced in the form of toroidal rings, which due to the laws, are more stable and can achieve a greater throwing range.

A second way is to produce the vapor bubbles in a first nozzle. This nozzle can be surrounded by an annular nozzle that produces a liquid sheath flow or can feed into a shared nozzle antechamber into which a liquid flows in a pulsed or non-pulsed fashion. For example also via an annular line around the vapor nozzle or in some other way.

The liquid sheath flow or the flow in the nozzle antechamber produces a directed flow that is likewise suitable for entraining the vapor bubbles and conveying them to the surface to be cleaned.

With this method as well, the conveying of the vapor bubbles can be assisted by a pulsed or non-pulsed replenishing flow of liquid into the vapor nozzle and/or the surrounding nozzle/line.

In all cases, the vapor bubbles collapse after a certain time since they change in their aggregate state due to a temperature drop and due to the cooling by the surrounding liquid that fills the closed volume.

This causes a pressure compensation, which results in a flow that exerts a shear force or shear stress on the oral biofilm, which causes the latter to detach and is sufficient for this purpose. (Combination with particles in the fluid.)

In this case, due to the size of the vapor bubbles, the shear stresses are much higher than with bubbles produced by ultrasound.

Due to the flowing transport liquids for the vapor bubbles, there are also flow conditions, which ensure that the biofilm does not stick to itself again, but is instead transported away.

Another purpose of the transport liquids is to prevent an increasing heating of the liquid in the closed volume and, when these liquids are correspondingly tempered, serve to cool both the heating devices and the liquid in the closed volume.

The nozzles, which eject the bubbles and/or the liquid, can in this case be circular in cross-section, but can also have any other shape, for example elliptical or narrow slit-shaped, star-shaped, or generally irregular.

The nozzle geometry also influences what shape the vapor bubbles assume. In particular, it can be advantageous if the vapor bubbles are ejected in the form of a toroidal ring.

For these nozzle geometries, the hydraulic diameter can be used as a substitute diameter Dh=4*A/P, where A=cross-sectional area and P=wetted circumference.

The circular toroidal ring of vapor bubbles is advantageous because it is particularly stable and propagates far into the liquid without any noticeable change in shape.

However, the stability of other geometries may well be sufficient for the required cleaning distance and permit an adaptation to the tooth geometry.

It has been discovered that at a ratio of the length of the liquid cylinder, which is ejected before the vapor volume, to its diameter of up to a maximum of 4, these tori form.

At a ratio above this, up to about 10, a mixed range exists whose boundaries are not sharp.

Exactly how far the mixed range extends and where a pure jet exists is fluid and therefore cannot be determined precisely.

Information about this can be found in D. G. Akhmetov “Vortex Rings” ISBN 978-3-642-05015-2, in particular FIGS. 3.6 and 3.7.

FIG. 3.7 shows the relationships quite clearly, where Up*t is the so-called slug length, i.e. the cylinder length of the ejected fluid. Up=velocity of the fluid, t=ejection time, and D=nozzle diameter.

At Up*t/D=2 a clear torus is observed, at 3.8 (approx. 4) it is still a torus, while at 8 there is already a mixture of a torus and a jet, i.e. a mixed form which also contains secondary smaller vortices.

FIG. 3.6 from the same book shows that starting from Up*t/D=3.8, the circulation no longer goes into the torus for all practical purposes.

Among other things, toroidal rings also have the advantage that they can bridge a large distance range between the nozzle and the surface to be cleaned.

In addition, toroidal rings that transport the vapor in their core can also bridge much greater distances than are necessary for the purpose specified here. In the free liquid, toroidal rings with hot vapor travel up to about 30 to 50 mm with nozzle diameters of around 1.5 mm. This means that when toroidal rings are used, a surface to be cleaned is reliably reached in every case.

This produces a method that achieves the contactless tooth cleaning by means of the implosion of vapor bubbles that are specifically produced by means of heating. This method can be used on the tooth surfaces, for example in the form of a brush head that encloses the tooth and is supplied with a liquid volume.

By contrast with conventional methods, the vapor bubbles in this case are produced by means of the vaporization of a cleaning solution. The cleaning solution can on the one hand be the usual water, but a special liquid can also be used, which is adapted to the cleaning parameters as a function of the special composition with alcohols, etc. by means of a corresponding thickening by means of thickeners, or by means of the addition of cleaning intensifiers (particles, cellulose fibers, etc.), and by means of its degree of degassing.

The vapor bubbles are produced in a controlled size based on the nozzles that are used. The bubble size in this case has a decisive influence on the cleaning intensity and the size of the cleaning spot.

In order to bring the produced vapor bubbles to the tooth, the vapor bubble production is combined with the production of a corresponding flow, which ensures that the vapor bubbles are transported to the tooth surface and into the interdental space before they implode.

The overall cleaning intensity is determined primarily by the shape and size of the vapor bubbles, the degree of degassing of the liquid, the viscosity of the liquid, and the influence of particles or fibers incorporated into the liquid.

The cleaning effect of the collapsing vapor bubble depends significantly on the dynamics of the collapse. In order to achieve cleaning of dental plaque, the time that the vapor bubble needs to collapse should be in the range from 0.01 to 0.5 ms or more precisely, a time between 0.050 ms and 0.25 ms.

When a selected cleaning configuration consisting of cleaning liquid and vapor bubble size is used, the time that the vapor bubble needs to collapse completely must be adjusted so that on the one hand, a cleaning effect is achieved and on the other hand, the tooth surface is not damaged. The resulting collapse time in this case can be correspondingly adjusted with the aid of the degassing rate of the cleaning liquid. An increase in the degassing rate in this case extends the time needed for the collapse.

In one modification, a closed treatment chamber is provided according to the invention, wherein a cushion-like element or sealing element produces a cleaning fluid volume in front of the nozzle, in particular by means of elastic sealing lips that are positioned around the nozzles or a nozzle assembly and also rest against the teeth in an elastically sealing fashion. In particular, the sealing cushion can adapt to the surfaces. In this connection, “sealing” or “creating a liquid volume” does not mean that this volume is absolutely liquid-tight; leakage of liquid is inevitable to a certain extent and can easily be accepted.

It can also be advantageous if a certain amount of leakage of liquid but not of particles occurs because particles can thus concentrate in the cleaning fluid volume, which in turn results in more cleaning particles per pulse and per nozzle and thus in better cleaning performance. The concentration in this case can occur by means of the sealing lips if they hold back the particles more powerfully than the fluid. The particles then only have to be supplied at a lower concentration with the fresh cleaning fluid, which in turn advantageously impedes or prevents a clogging of the supply lines.

Accordingly, due to its elasticity, the cushion can catch at least most of the volume flowing in through the nozzle; incidentally, complete tightness is also not out of the question. Ideally, therefore, the closed volume between the nozzle and the surface to be cleaned does not lose any cleaning liquid and, ideally, the cleaning liquid can thus be reused an infinite number of times by being sucked in and ejected, for the respective cleaning jet. But since in reality, losses of cleaning fluid appear to be inevitable, for example due to interdental spaces or leaks at the sealing lips due to the surface shape of the surface to be cleaned, which must be compensated for by an inflow of cleaning liquid, the total inflow is greater than the volume.

The inflow in this case can take place through the respective nozzle through which the vapor bubble is also ejected, a liquid nozzle provided especially for this purpose, or through one or more nozzles in a nozzle assembly equipped with multiple nozzles so that an average flow of fluid flows through the nozzle or nozzles. But the closed volume can also be replenished with a sufficient amount of cleaning liquid from elsewhere.

As explained above, the nozzle shape can deviate from a circular cross-section and can have any other shape. In longitudinal section, the nozzle can be embodied as cylindrical or without divergence or convergence of the boundary walls, but can also be embodied as conical.

For the pulsing required to generate the toroidal ring, the driving frequencies of the pulsation are between 1 Hz and 50 kHz, in particular between 1 Hz and 30 kHz, and especially from 1 Hz to 1 kHz.

Particularly when producing spheroidal vapor bubbles, the pulsation frequency is preferably between 1 Hz and 1 kHz, in particular between 30 Hz and 300 Hz, and preferably >50 Hz.

Particularly when generating hot-vapor toroidal rings, the pulsation frequency is preferably between 1 Hz and 20 kHz, preferably from 50 Hz to 1 kHz, and more preferably from 50 Hz to 300 Hz.

Pulsation frequencies of >50 Hz are quite reasonable, because in this way a short cleaning time can be achieved with a comfortable shuttle size (number of nozzles).

For example, pulse lengths range from 0.03 milliseconds to 1 second.

Particularly when generating a vapor bubble, the pulse lengths are 0.3 ms-1 sec, preferably 0.3 ms-500 ms, more preferably 0.3 to 100 ms, even more preferably 0.3 to 20 ms, and in particular 0.3 ms-5 ms.

Particularly when generating a vapor-bubble toroidal ring, the pulse lengths can be shorter and in particular, are 0.03 ms-3 ms, particularly 0.07 ms to 0.7 ms, preferably 0.1 ms to ms. The also depends on the size of the torus.

When using particles, particles from 1 μm to 0.5 mm can be used.

The desired particle density in the closed volume is preferably less than 30 percent by volume, in particular less than 20 percent by volume, and especially less than 15 percent by volume relative to the liquid contained in the closed volume.

The desired particle density in the initial cleaning liquid that is conveyed in the device is preferably less than 10 percent by volume, in particular less than 5 percent by volume, in each case relative to the volume of the cleaning liquid.

The closed volume according to the invention, which can be closed off by means of corresponding sealing lips or other sealing elements, has turned out to be helpful to the inventors since for many people, it is uncomfortable when the mouth is filled with cleaning fluid and in particular, the fluid volume continues to increase and, when the device is removed, cleaning fluid that is still present runs out of the mouth or soils clothing.

According to the invention, the cleaning fluid is correspondingly kept within the closed volume; after the end of the cleaning process, the cleaning liquid contained in the closed volume can also be completely sucked out by means of the above-described back-suction according to the invention.

In this case, the closed volume can be produced around one or more teeth, closed around a jaw branch or for example around differently shaped teeth depending on the tooth shape, for example so that one volume is produced around molars, one volume is produced in the canine region, and one volume is produced in the incisor region.

A total volume for an entire jaw can also be produced with corresponding nozzle assemblies, but partitions or dividers, in particular elastic partitions or dividers, for example, are provided between the differently shaped regions delimiting the volume, which also support the nozzles.

The design is thus flexible, but all of the possible options share the fact that the closed volume holds the fluid around the surface and significantly reduces the amount of fluid in the mouth.

As explained above, there are also multiple variants according to the invention when it comes to the liquid guidance.

The invention thus relates in particular to a method for cleaning surfaces, wherein a liquid volume is produced on or around a surface to be cleaned and hot vapor bubbles and/or bubbles composed of a superheated vapor are produced and directed at the surface to be cleaned using at least one assembly comprising at least one nozzle and a heating device.

According to one modification, a liquid is also ejected in a pulsed fashion.

According to one modification, the liquid in front of the vapor bubble is ejected from the same nozzle or from at least one other nozzle.

According to one modification, the heating of the cleaning liquid takes place upstream of or in the at least one nozzle in a pulsed fashion with a predetermined pulsing frequency.

In one modification, an assembly with multiple nozzles is used.

According to one modification, heat input is used to produce a vapor bubble in a nozzle, wherein a liquid volume in front of the vapor bubble in the ejection direction in a nozzle assembly is ejected by means of the expansion, wherein this ejected volume produces a pressure jet or pressure pulse of a predetermined strength and speed in the direction of the surface to be cleaned.

According to one modification, according to the fluid dynamics, a negative pressure is produced at the rear end of the pressure surge so that the vapor bubble is entrained by this lower-pressure region, wherein behind the vapor bubble, liquid to be vaporized with a predetermined pressure is fed into the region of the heater and from there, onward to an ejection opening of the nozzle.

According to one modification, the liquid to be vaporized is supplied to the nozzle in a cyclically pulsed fashion.

According to one modification, when surfaces are not flat or as a function of a distance from the surface, the nozzles are operated so that one or more of the following measures are regulated in terms of their chronologically constant and chronologically changing amplitude: the pulse strength of the liquid ejected from the nozzle, the quantity of the liquid ejected from the nozzle, the size of the hot-vapor bubble, the speed of the hot-vapor bubble, and the vapor temperature of the vapor of the hot-vapor bubble.

According to one modification, with a greater distance, one or more of the following parameters is increased: the pulse strength, the pulse duration, the pulse frequency, the supply quantity of liquid, the bubble size, and the vapor temperature.

According to one modification, the pulse strength is varied in time in order to increase the penetration depth of the vapor bubble being pulled by the liquid droplet.

According to one modification, the at least one nozzle oscillates around a home position in the X direction (surface vertical axis) and/or Y direction (surface transverse axis) and/or Z direction (surface the tooth).

According to one modification, the at least one nozzle is guided along the surface.

According to one modification, multiple nozzles are combined to form a nozzle assembly, wherein the nozzles are arranged so that they are positioned at least across one direction of the surface (X or Y), wherein the nozzle jet impingement surfaces of the individual nozzles overlap or, in the case of oscillating nozzle assemblies, the nozzle jet impingement surfaces of the nozzle assemblies overlap.

According to one modification, a different nozzle density per unit area of the assembly is used across one direction of a surface, with a higher number of nozzles being used in the regions in which the assembly is spaced farther away from the surface to be cleaned.

According to one modification, multiple nozzles are combined in a respective shuttle device, wherein the shuttle device encompasses at least the region of one tooth and the adjacent gums in an inverted U-shape.

According to one modification, the shuttle device is moved over the surface with a moving device.

According to one modification, 10 to 100 nozzles are used per shuttle device.

According to one modification, nozzles with different diameters and/or different flow lengths are used.

According to one modification, vapor bubbles in the form of toroidal rings are produced.

According to one modification, pulsing is produced at a pulse frequency of between 50 and 300 Hz.

According to one modification, the distance from a surface to be cleaned is set so that it is between 0.5 mm and 5 mm and at most 7 mm in the interdental space.

According to one modification, the absolute inlet pressure, i.e. the pressure of the liquid in the supply line including the ambient pressure of the cleaning liquid in front of the heater in the nozzle, is set to 0.1 to 2 MPa, preferably 0.12 to 0.6 MPa.

According to one modification, the cleaning liquid contains 0.1-5% by volume of particles.

According to one modification, mineral particles or cellulose-based particles are used as the particles.

According to one modification, particles with a particle size of 20-120 μm are used.

According to one modification, in order to keep the amount of liquid in the volume constant, a portion of the liquid is sucked out of the volume, which essentially corresponds to the amount of liquid supplied via the at least one nozzle.

According to one modification, the particle density in the closed volume is below 30 percent by volume, in particular below 20 percent by volume, and especially below 15 percent by volume relative to the liquid contained in the closed volume.

According to one modification, the particle density in the initial cleaning liquid that is conveyed in the device is less than 10 percent by volume, in particular less than 5 percent by volume, in each case relative to the volume of the cleaning liquid.

According to one modification, in order to achieve cleaning of biofilm like dental plaque, the time that the vapor bubble needs to collapse is set to be in the range from 0.01 to 0.5 ms or more precisely, between 0.050 ms and 0.25 ms.

According to one modification, in the pulsing required to generate toroidal rings, the driving frequencies of the pulsation are between 1 Hz and 50 kHz, in particular between 1 Hz and 30 kHz, and especially from 1 Hz to 1 kHz and when producing spheroidal vapor bubbles, the pulsation frequency is preferably between 1 Hz and 1 kHz, in particular between 30 Hz and 300 Hz, and preferably >50 Hz.

According to one modification, the pulse lengths are 0.03 milliseconds to 1 second, wherein when generating a vapor bubble, the pulse lengths are 0.3 ms-1 sec, preferably 0.3 ms-500 ms, more preferably 0.3 to 100 ms, even more preferably 0.3 to 20 ms, and in particular ms-5 ms and when generating a vapor-bubble toroidal ring, the pulse lengths are shorter and in particular, are 0.03 ms-3 ms, particularly 0.07 ms to 0.7 ms, and preferably ms to 0.4 ms.

Another aspect of the invention relates to a cleaning device for cleaning surfaces, in particular for carrying out the above-described method, wherein that the device has a liquid reservoir for supplying a cleaning liquid, wherein at least one wall oriented toward a surface to be cleaned is provided with at least one through opening, wherein the through opening has a heating device or a heating device is provided that is positioned inside the liquid reservoir adjacent to the through opening, wherein the heating device is embodied so that it vaporizes the cleaning liquid inside the through opening or in the liquid reservoir upstream of the through opening.

According to one modification, the at least one through opening is embodied as a nozzle.

According to one modification, the diameter of the through opening is 150 μm to 400 μm so that vapor bubble sizes from 150 to 600 μm are produced.

According to one modification, oriented toward a surface to be cleaned, the device has at least one sealing element, which extends from the device to the surface to be cleaned and is embodied to rest against the latter in a sealing fashion, wherein the at least one sealing element is embodied so that it forms a closed volume between the device and the surface to be cleaned.

According to one modification, the at least one sealing element is embodied as rubber-elastic.

According to one modification, means are provided with which the liquid in the liquid reservoir is kept at a predetermined pressure so that the vapor bubble is prevented from flowing back into the liquid reservoir.

According to one modification, in order to ensure a degassing of the closed volume and/or to avoid an overfilling of the closed volume, means are provided, which make it possible to suck liquid out of the closed volume or to suck air bubbles out of the closed volume during filling.

According to one modification, the device is embodied as U-shaped in cross-section, wherein the liquid reservoir is embodied as U-shaped in cross-section with a base body and two wings protruding out from it so that it is possible to embrace a three-dimensional, protruding surface to be cleaned.

According to one modification, the base body and the wings each have at least one through opening, whereby the at least one sealing element extends to the surface to be cleaned.

According to one modification, the through opening is embodied with a core nozzle that is concentrically surrounded by a sheath nozzle, which produces a liquid sheath flow, or feeds into a shared nozzle antechamber into which a liquid flows in a pulsed or non-pulsed fashion.

According to one modification, in the annular nozzle, a liquid sheath flow is produced that is suitable for entraining the vapor bubbles, which are produced in the core nozzle by heating, and conveying them to the surface to be cleaned or else the liquid flow is produced in the core nozzle and the vapor bubble is produced in the sheath nozzle.

According to one modification, the heating structure is provided spaced apart from the outlet opening inside the liquid reservoir and situated opposite from the enclosed volume, wherein the heating structure is a flat heating element, which is preferably produced using the thin-film technique and for example comprises a glass substrate and metal electrodes such as platinum electrodes.

According to one modification, the heating element is embodied to heat cleaning liquid, which is flowing in front of the heating element, very quickly so that a vapor bubble forms, wherein because of the expansion of the vapor bubble, the portion of liquid that is in the through opening is accelerated into the closed volume in the direction of the surface to be cleaned and the vapor bubble, when heated by the heating element, enlarges until it detaches from the heating element and moves together with the droplet in the direction toward the surface to be cleaned.

According to one modification, the through opening for producing toroidal rings has a ratio of the length of the liquid cylinder ejected in front of the vapor bubble to its diameter of up to at most 10, preferably at most 4.

According to one modification, the heating elements are pulsed micro-cavity vaporizer elements.

Another aspect of the invention relates to the use of the above-described method and/or the above-described device for cleaning an oral cavity and in particular teeth, interdental spaces, and gums.

One modification provides for a use of the method, wherein the at least one nozzle oscillates around a home position in the X direction (tooth vertical axis) and/or Y direction (tooth transverse axis) and/or Z direction (toward the tooth).

One modification provides for a use of the method, wherein the at least one nozzle is guided along the teeth.

One modification provides for a use of the method, wherein the nozzles are positioned so that they extend at least across the height of one tooth and the adjacent gums.

### BRIEF DESCRIPTION OF THE DRAWINGS

The invention will be explained by way of example with the aid of drawings. In the drawings:

FIG. 1: shows a one-sided cleaning device against the tooth, with multiple nozzles and sealing lips;

FIG. 2: shows a U-shaped shuttle enclosing the tooth, with multiple nozzles and sealing lips;

FIG. 3: shows the movement of the vapor bubble and the preceding droplet;

FIG. 4: shows the production of the vapor bubbles in a tube within a tube;

FIG. 5: shows the production of vapor bubbles in a tube within a tube as a sequence;

FIG. 6: shows the production of vapor bubbles by means of a vaporizing actuator;

FIG. 7: shows the production of vapor bubbles by means of a vaporizing actuator as a sequence;

FIG. 8: shows the transport of the vapor in the torus and by means of a droplet compared to each other;

FIG. 9: shows a three-sided, tooth-embracing shuttle with MEMS elements.

### DETAILED DESCRIPTION OF THE INVENTION

The invention is basically suitable for cleaning surfaces that are covered with a comparatively soft, but quite adhesive coating.

In particular, the method according to the invention and the device according to the invention, which will be described in greater detail below, can be used for cleaning in the oral cavity and particularly for cleaning teeth and gums.

Whenever teeth or gums are mentioned below as a surface, this is understood to be meant as an example. This expressly includes other surfaces.

The general statements made above, particularly with regard to the technical embodiment and specifications, also apply to the example below, unless other values or parameters are expressly mentioned.

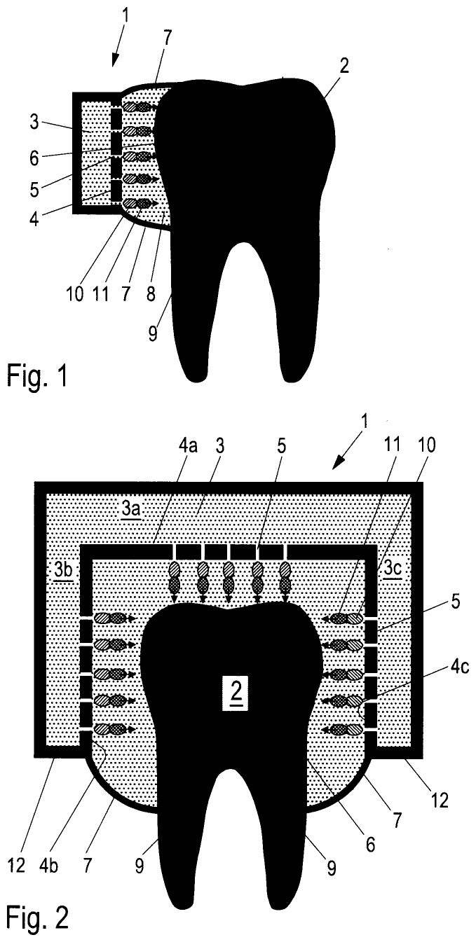

FIG. 1 is a very schematic depiction of a first possible embodiment of the device 1 according to the invention. The device 1 in this case is used for cleaning a surface on a tooth 2, which in this case is the flank of a tooth.

The device 1 in this case has a liquid reservoir 3. In a wall 4 oriented toward the surface to be cleaned, multiple through openings 5 are provided. The through openings 5 can, for example, be embodied as nozzles and be used to enable the flow, particularly of liquid, from the liquid reservoir 3 in the direction of the surface to be cleaned 6.

In the vicinity of the wall 4, the device 1 has sealing elements 7 and in particular sealing lips 7, which extend from the device 1 and in particular, from a region of the wall 4 to a surface to be cleaned 6 and rest against the latter. The sealing elements 7 in this case are embodied so that they form a closed volume 8 between the device 1 or more precisely, the wall 4 of the device 1, and the surface to be cleaned 6. This means that the sealing elements shown can also be a single sealing element and thus a circumferential sealing lip.

The sealing element 7 or sealing elements 7 in this case are particularly embodied as rubber-elastic and also, in order to compensate for irregularities in the surface 6, can be embodied in the form of a bellows with folds, wherein the surface of the sealing elements 7 against a surface to be cleaned 6 can have an enlarged contact surface. This enlarged contact surface 9 can, for example, have a micro-contouring, for example in the form of fins that enhance the sealing effect.

The through openings 5 or nozzles 5 in this case are embodied with a heating device (not shown) so that they can produce a very quick heating of a liquid in their vicinity until the vapor phase can be achieved. By means of this, it successfully produces a gas bubble 10, which is preceded by a liquid droplet 11 in the direction toward the surface to be cleaned. This directed movement of the gas bubble 10 and the liquid droplet 11 can be produced on the one hand by the fact that the liquid in the liquid reservoir 3 is at a certain pressure and the through openings 5 optionally have a shape, which, with the sudden vaporization of the liquid, causes a forward-directed movement, i.e. the nozzles or through openings 5 widen out in funnel fashion, for example, in the direction toward the surface to be cleaned 6.

In order to produce the movement of the vapor bubble 10 and the droplet 11, the closed volume 8 is filled with a liquid, wherein for self-evident reasons, the liquid in the closed volume 8 preferably corresponds to the liquid in the liquid reservoir 3, i.e. on the whole, the cleaning liquid that is vaporized is present both in the closed volume 8 and in the liquid reservoir 3.

This can be achieved, for example, in that before the heating units in the through openings 5 or nozzles 5 are activated, cleaning liquid is pumped into the closed volume 8 through these nozzles until the closed volume 8 is filled with the cleaning liquid. In order to ensure a corresponding degassing of the closed volume 8, an excess of cleaning liquid can be pumped in and sucked back out by means of a back-suction device (not shown) so that no air bubbles are contained.

In one advantageous embodiment of the device 1, it is embodied in the form of an inverted U shape, wherein the liquid reservoir 3 is embodied in the form of an inverted U shape, with a base body 3a and two wings 3b and 3c protruding from the latter at right angles. The walls 4a, 4b, and 4c facing the surface to be cleaned 6 are each provided with at least one through opening 5 or nozzle 5, wherein the sealing elements 7 or the circumferential sealing element 7 extend from the walls 4b and 4c or the adjacent end walls 12 to the surface to be cleaned 6. Such a device 1 can therefore be used to act from all sides on a three-dimensionally protruding surface to be cleaned, for example a tooth 2.

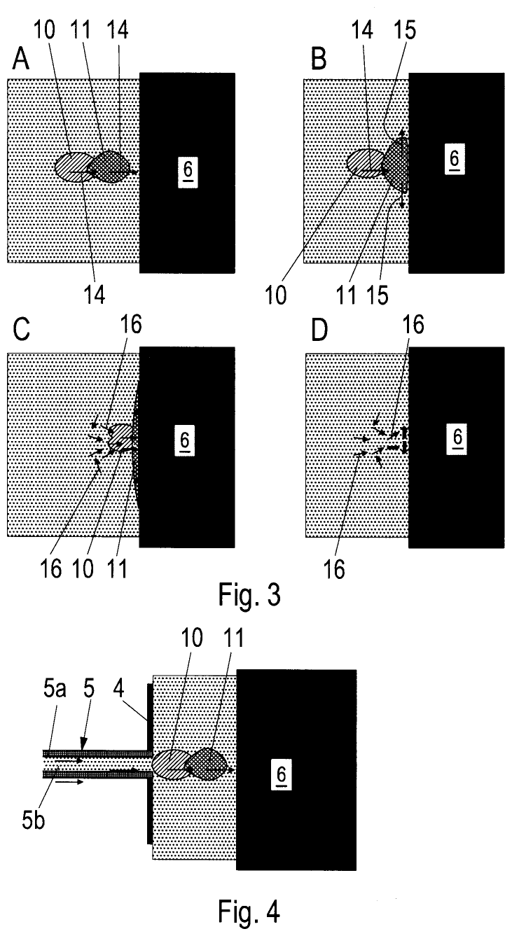

FIG. 3 shows a sequence in which a droplet 11, which precedes a vapor bubble 10 that has pushed it out from the through opening 5. This droplet then strikes the surface to be cleaned 6. The movement direction toward the surface to be cleaned 6 is indicated by the arrow 14, wherein at the surface after the impact, this movement direction is joined by transverse flows, which are indicated by the arrows 15. When the vapor bubble 10 strikes the surface 6, after the droplet 11 has spread out, micro-flows corresponding to the arrows 16 are produced when the gas bubble or vapor bubble 10 implodes, wherein this causes the corresponding transverse flows 16 in the liquid, thus producing the cleaning effect that has already been discussed above.

FIG. 4 shows an embodiment of the through opening or nozzle. In this case, a core nozzle 5b is surrounded by an annular nozzle of the sheath nozzle 5a, which produces a liquid sheath flow or feeds into a shared nozzle antechamber (not shown) into which a liquid flows in a pulsed or non-pulsed fashion. The liquid sheath flow in the annular nozzle 5a produces a directed flow, which is likewise suitable for entraining vapor bubbles 10, which are produced in the core nozzle 5b by heating, and guiding them to the surface to be cleaned 6. Here, too, the conveying of the vapor bubbles 10 can be assisted by a pulsed or non-pulsed replenishing flow of liquid into the vapor nozzle and/or the surrounding nozzle.

Naturally, the vapor can also be produced in the annular nozzle 5a and the liquid flow can take place through the central core nozzle 5b.

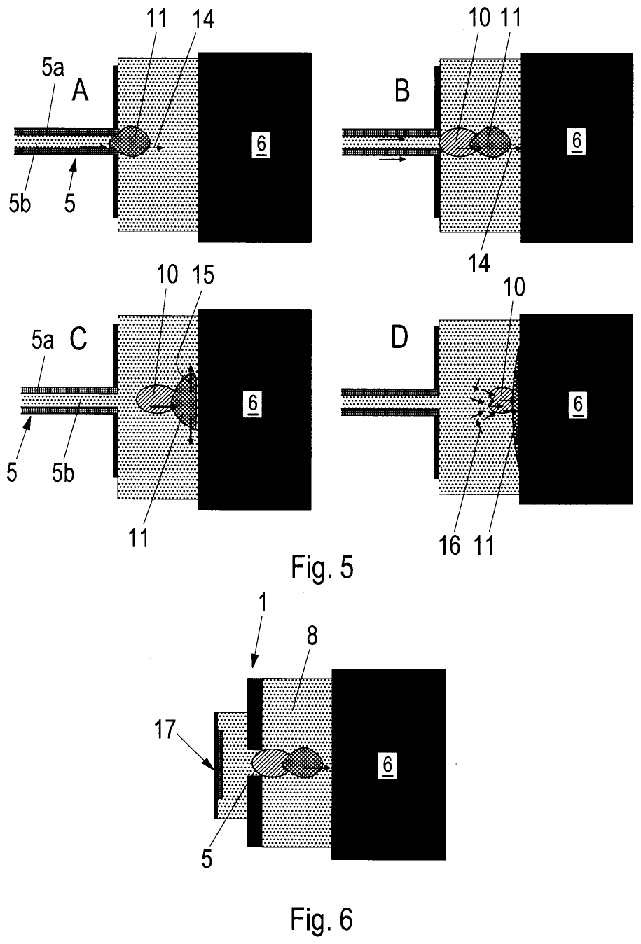

This is shown in FIG. 5 in which first, a liquid pulse produces a preceding droplet 11, which is conveyed in accordance with the arrow direction 14 toward the surface to be cleaned. In the annular nozzle 5a, vapor is produced for this purpose in a phased or cyclical fashion, which is then guided following the liquid droplet 11 and entrained by the latter in accordance with the arrow direction 14 toward the surface to be cleaned 6. Then the effects that have already been described above can be ascertained by the spreading of the droplet 11 and the subsequent impact of the vapor bubble 10 and its implosion.

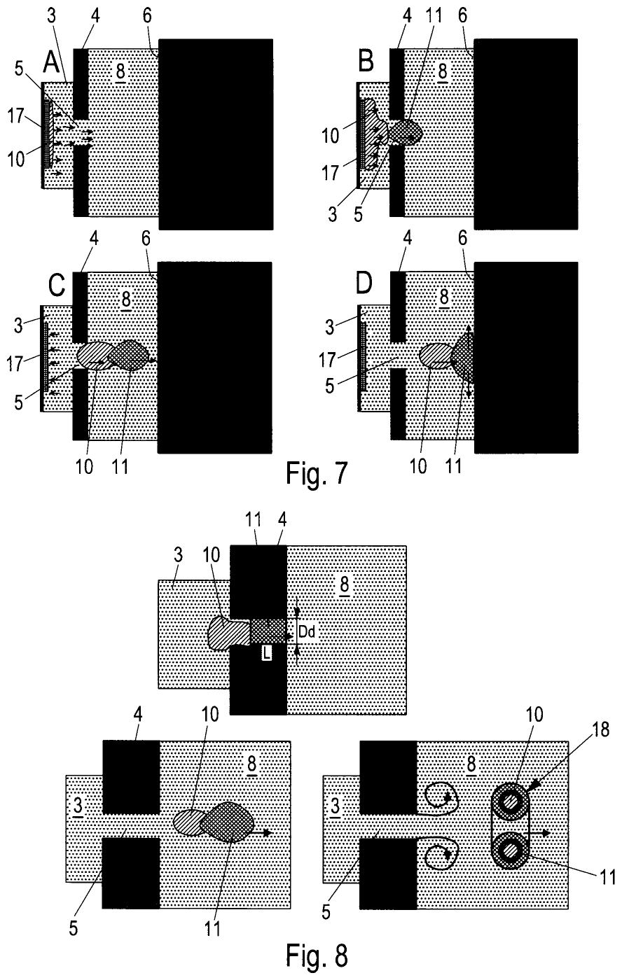

FIG. 6 is a very schematic depiction of another embodiment of the device 1. With this device as well, a closed volume is formed in front of a surface to be cleaned. Also in this embodiment, a through opening 5 is provided. A heating structure 17 is provided that is spaced apart from the outlet opening 5 and situated opposite from the closed volume, wherein the heating structure 17 is a flat heating element 17, which is preferably produced using the thin-film technique and for example comprises a glass substrate and metal electrodes such as platinum electrodes. The heating element 17 in this case functions as follows: first, cleaning liquid flows in front of the heating element 17, this cleaning liquid is then heated by the heating element 17 very quickly so that a vapor bubble 10 forms, which still sticks to the heating element, as shown in FIG. 7, top right. Because of the expansion of the vapor bubble 10, the portion of liquid that is in the through opening 5 is accelerated into the closed volume 8 in the direction of the surface to be cleaned 6 and the vapor bubble 10 enlarges further until, as shown in FIG. 7, bottom left, it detaches from the heating element 17 and moves together with the droplet 11 in the direction toward the surface to be cleaned 6. After the release of the gas bubble 10 from the heating element 17, cleaning liquid flows to the heating element 17 once again and can once again be heated there.

This can be assisted by the fact that the heating element 17 and the cleaning liquid inside the liquid reservoir 3 in which the heating element 17 is situated are at a predetermined pressure so that the released volume of the vapor bubble is compensated for by the inflow. Basically, the aim is to set the diameter of the through opening 5 to from 150 μm to 400 μm so that vapor bubble sizes of 150 to 600 μm are produced.

In order to produce the vapor bubbles, the previously mentioned flat heating elements 17 are used or heated needles inside the through openings 5, which are embodied with capillaries, i.e. through openings, with a diameter of 150 to 400 μm. The cleaning liquid is preferably degassed and has a degree of degassing of 100% to 25%.

With appropriate ratios of length to diameter of the nozzles 5, it is possible to produce toroidal rings, as already discussed above. The production of toroidal rings is shown in a very schematic form in FIG. 8 wherein the corresponding through opening with the corresponding parameters is embodied in the wall 4. If a vapor bubble 10 then pushes a corresponding liquid volume 11 out from the nozzle, then the liquid volume 11 that has been pushed out quickly produces a toroidal ring 18, which consists of an annular flow of the liquid droplet 11, wherein the annular gas bubble 10 is formed in the core of this annular flow.

It has been discovered that at a ratio of the length of the liquid cylinder ejected in front of the vapor bubble to its diameter of up to at most 4, these tori form.

At a ratio above this, up to about 10, a mixed range exists whose boundaries are not sharp.

Exactly how far the mixed range extends and where a pure jet exists is fluid and therefore cannot be determined precisely.

For the pulsing required to generate the toroidal ring, the driving frequencies of the pulsation are between 1 Hz and 50 kHz, in particular between 1 Hz and 30 kHz, and especially from 1 Hz to 1 kHz.

Particularly when producing spheroidal vapor bubbles, the pulsation frequency is preferably between 1 Hz and 1 kHz, in particular between 30 Hz and 300 Hz, and preferably >50 Hz.

Particularly when generating hot-vapor toroidal rings, the pulsation frequency is preferably between 1 Hz and 20 kHz, preferably from 50 Hz to 1 kHz, and more preferably from 50 Hz to 300 Hz.

Pulsation frequencies of >50 Hz are quite reasonable, because in this way a short cleaning time can be achieved with a comfortable shuttle size (number of nozzles).

For example, pulse lengths range from 0.03 milliseconds to 1 second.

Particularly when generating a vapor bubble, the pulse lengths are 0.3 ms-1 sec, preferably 0.3 ms-500 ms, more preferably 0.3 to 100 ms, even more preferably 0.3 to 20 ms, and in particular 0.3 ms-5 ms.

Particularly when generating a vapor-bubble toroidal ring, the pulse lengths can be shorter and in particular, are 0.03 ms-3 ms, particularly 0.07 ms to 0.7 ms, preferably 0.1 ms to 0.4 ms. The also depends on the size of the torus.

When using particles, particles from 1 μm to 0.5 mm can be used.

The desired particle density in the closed volume is preferably less than 30 percent by volume, in particular less than 20 percent by volume, and especially less than 15 percent by volume relative to the liquid contained in the closed volume.

The desired particle density in the initial cleaning liquid that is conveyed in the device is preferably less than 10 percent by volume, in particular less than 5 percent by volume, in each case relative to the volume of the cleaning liquid.

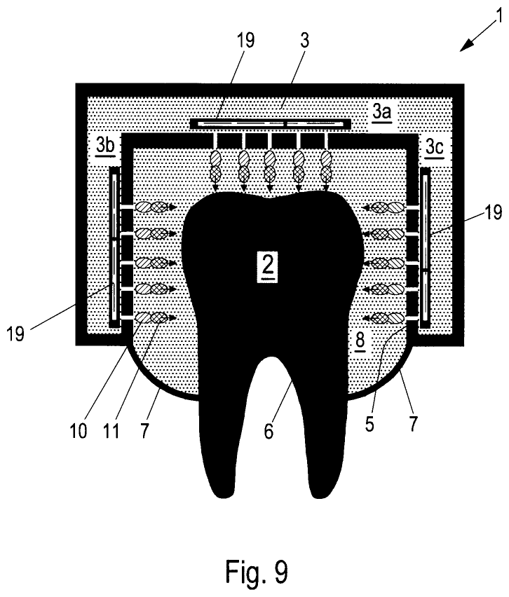

FIG. 9 shows a corresponding device 1, which essentially corresponds to the device in FIG. 2; parts that are the same have been provided with the same reference numerals.

In this embodiment, inside the liquid reservoir 3, which in turn is composed of three subelements 3a, 3b, and 3c, which are positioned in a U shape around a three-dimensional surface to be cleaned, a tooth 2 in this example, flat heating elements 17 are embodied in the form of so-called MEMS elements. These MEMS elements are flat micro-electromechanical systems, which combine logic elements and micromechanical structures in a chip. These elements are able to achieve a corresponding vapor production in order to produce the vapor bubbles 10, particularly by means of the sudden heating of the liquid situated in front of the MEMS element.

For example, the MEMS element is a so-called pulsed micro-cavity vaporizer element, which is particularly suitable for the pulsed operating mode. In this case, the corresponding element can on the one hand mechanically produce a pulsating flow and can also in parallel produce the water vapor through heating.

In this connection, it is advantageous that this technology functions properly with low heating outputs so that there is no risk of an excessive heating of the cleaning liquid.

Naturally, toroidal rings can also be produced in this way.

The invention has the advantage that an effective cleaning of surfaces can be achieved using very small structures and avoids damaging the surface or adjacent surfaces.

The device and method can advantageously be used with particular success for cleaning in the oral cavity.

1-51. (canceled)

52. A method for cleaning surfaces, comprising the steps of:
producing a liquid volume around a surface to be cleaned;
using at least one assembly including at least one nozzle and a heating device to produce vapor bubbles composed of wet vapor, a saturated vapor, and/or a superheated vapor; and
ejecting the vapor bubbles from the at least one nozzle toward the surface to be cleaned.

53. The method according to claim 52, further comprising the step of ejecting a liquid in pulses from the at least one nozzle to produce the liquid volume.

54. The method according to claim 53, wherein the liquid is ejected in front of the vapor bubbles from the at least one nozzle or is ejected from at least one other nozzle.

55. The method according to claim 53, further comprising the step of heating the liquid upstream of or in the at least one nozzle.

56. The method according to claim 52, wherein the at least one assembly comprises multiple nozzles.

57. The method according to claim 54, further comprising the step of inputting heat to produce the vapor bubbles in the at least one nozzle, wherein a portion of the liquid in front of each vapor bubble in the at least one nozzle is ejected from the nozzle by an expansion of the vapor bubble that produces a pressure jet or pressure pulse of a predetermined strength and speed in a direction of the surface to be cleaned.

58. The method according to claim 57, wherein a negative pressure region is produced at a rear end of the pressure jet or pressure pulse so that the vapor bubble is entrained by the negative pressure region, further comprising the step of feeding a portion of the liquid to be vaporized with a predetermined pressure from behind the vapor bubble, into a heated region, and onward to an ejection opening of the nozzle.

59. The method according to claim 58, wherein the liquid to be vaporized is supplied to the nozzle in a cyclically pulsed fashion.

60. The method according to claim 53, further comprising the step of regulating at least one of a pulse strength of the liquid ejected from the nozzle, a quantity of the liquid ejected from the nozzle, a size of the vapor bubbles, a speed of the vapor bubbles, and a vapor temperature in the vapor bubbles.

61. The method according to claim 53, further comprising the step of increasing at least one of a pulse strength, a pulse duration, a pulse frequency, a supply quantity of liquid, a bubble size, and a vapor temperature, as a distance between the assembly and the surface to be cleaned is increased.

62. The method according to claim 53, further comprising the step of varying a pulse strength in order to increase a penetration depth of the vapor bubbles.

63. The method according to claim 52, further comprising the step of oscillating the at least one nozzle around a home position in an X direction, a Y direction perpendicular to the X direction, and/or a Z direction perpendicular to the X and Y directions.

64. The method according to claim 52, further comprising the step of guiding the at least one nozzle along the surface to be cleaned.

65. The method according to claim 52, wherein the assembly comprises multiple nozzles which can be arranged and positioned across an X direction and/or a Y direction of the surface to be cleaned.

66. The method according to claim 65, wherein the assembly comprises varying nozzle densities per unit area of the assembly, so that a higher nozzle density can be used in regions where the assembly is spaced farther away from the surface to be cleaned.

67. The method according to claim 65, wherein the assembly further comprises a U-shaped shuttle device, and the multiple nozzles are combined in the shuttle device.

68. The method according to claim 67, wherein the assembly further comprises a moving device for moving the shuttle device over the surface to be cleaned.

69. The method according to claim 67, wherein the shuttle device houses from 10 to 100 of the nozzles.

70. The method according to claim 65, wherein the multiple nozzles comprise nozzles having different diameters and/or different flow lengths.

71. The method according to claim 53, wherein the vapor bubbles are produced in a form of toroidal rings.

72. The method according to claim 53, wherein the pulses have a pulse frequency of between 40 and 400 Hz.

73. The method according to claim 52, further comprising the step of setting a distance from the assembly to the surface to be cleaned of between 0.5 mm and 5 mm.

74. The method according to claim 53, further comprising the step of injecting the liquid into the at least one nozzle in front of the heater using an inlet pressure of 0.1 to 2 MPa.

75. The method according to claim 53, wherein the liquid contains from 0.1-5% by volume particles.

76. The method according to claim 75, wherein the particles comprise mineral particles and/or cellulose-based particles.

77. The method according to claim 75, wherein the particles have a particle size of 20-120 μm.

78. The method according to claim 53, further comprising the step of maintaining a constant volume of the liquid in the at least one nozzle.

79. The method according to claim 52, wherein the liquid volume comprises particles in an amount of less than 30% by volume.

80. The method according to claim 53, wherein the liquid being injected into the at least one nozzle comprises particles in an amount of less than 10% by volume.

81. The method according to claim 52, wherein the vapor bubbles are configured to have a collapsing time of 0.01 to 5 ms after ejection from the at least one nozzle.

82. The method according to claim 53, wherein the pulses have a frequency of 1 Hz to 50 kHz to produce the vapor bubbles in the form of toroidal rings.

83. The method according to claim 53, wherein the pulses have pulse lengths of 0.03 milliseconds to 1 seconds.

84. A cleaning device (1) for cleaning surfaces, comprising:
a liquid reservoir (3) for supplying a cleaning liquid, including at least one wall (4) oriented toward a surface to be cleaned (6) provided with at least one through opening (5); and
a heating device (17) positioned inside the at least one opening (5) or in the liquid reservoir (3) adjacent to the at least one through opening (5);
wherein the heating device is configured so that it vaporizes the cleaning liquid inside the through opening (5) or in the liquid reservoir (3) upstream of the through opening (5).

85. The cleaning device according to claim 84, wherein the at least one through opening (5) is configured as a nozzle.

86. The cleaning device according to 84, wherein the through opening (5) has a diameter of 150 μm to 400 μm.

87. The cleaning device according to claim 84, further comprising at least one sealing element (7) that can be oriented toward the surface to be cleaned (6), which can extend from the device (1) to the surface to be cleaned (6) and is configured to rest against the surface to be cleaned (6) in a sealing fashion, forming a closed volume (8) between the device (1) and the surface to be cleaned (6).

88. The cleaning device according to claim 87, wherein the at least one sealing element (7) comprises an elastic rubber.

89. The cleaning device according to claim 84, wherein the liquid reservoir (3) is configured to maintain liquid at a predetermined pressure.

90. The cleaning device according to claim 87, further comprising a suction device configured to remove liquid and/or gas bubbles from the closed volume (8) during filling.

91. The cleaning device according to claim 84, wherein the cleaning device (1) has a U-shaped cross-section, and the liquid reservoir (3) has as U-shaped in cross-section with a base body (3a) and two wings (3b, 3c) protruding from the base body (3a).

92. The cleaning device according to claim 91, wherein the base body (3a) and the wings (3b, 3c) each have at least one of the through openings (5) and the at least one sealing element (7) is configured to extend from the wings (3b, 3c) to the surface to be cleaned (6).

93. The cleaning device according to claim 84, wherein the at least one through opening (5) is configured with a core nozzle (5b) that is concentrically surrounded by a sheath nozzle (5a).

94. The cleaning device according to claim 93, wherein the sheath nozzle (5a) is configured to produce a liquid sheath flow that is suitable for entraining vapor bubbles (10), and the core nozzle (5b) is configured to produce the vapor bubbles (10) by heating.

95. The cleaning device according to one of claims 33 to 43, wherein the heating device (17) is positioned inside the liquid reservoir (3) spaced apart from the at least one opening (5) and is positioned opposite from the enclosed volume (8), and the heating device (17) comprises a flat element.

96. The cleaning device according to claim 84, wherein the heating element (17) is configured to heat cleaning liquid flowing in front of the heating element (17) sufficiently quickly to form vapor bubbles (10) which expand to accelerate a portion of the cleaning liquid from the through opening (5) into the closed volume (8) toward the surface to be cleaned (6).

97. The cleaning device according to claim 84, wherein the at least one through opening (5) has a ratio of length to diameter of up to 10.

98. The cleaning device according to claim 84, wherein the heating device (17) comprises pulsed micro-cavity vaporizer elements.

99. A use of a cleaning device (1) for cleaning an oral cavity, wherein the cleaning device (1) comprises:
a liquid reservoir (3) for supplying a cleaning liquid, including at least one wall (4) oriented toward a surface to be cleaned (6) provided with at least one through opening (5); and
a heating device (17) positioned inside the at least one opening (5) or in the liquid reservoir (3) adjacent to the at least one through opening (5);
wherein the heating device is configured so that it vaporizes the cleaning liquid inside the through opening (5) or in the liquid reservoir (3) upstream of the through opening (5).

100. A use of the cleaning device (1) according to claim 99, wherein the at least one through opening (5) comprises a nozzle that oscillates around a home position in an X direction, a Y direction perpendicular to the X direction, and/or a Z direction perpendicular to the X and y directions.

101. A use of the heating device (1) according to claim 100, wherein the at least one nozzle is guided along teeth in the oral cavity.

102. A use of the heating device (1) according to claim 101, wherein the heating device comprises a plurality of the nozzles and the nozzles are positioned to extend at least across a height of one tooth and adjacent gums.
